(19) United States
(12) Patent Application Publication
(10) Pub. No.: US 2004/0144405 A1
(43) Pub. Date: Jul. 29, 2004

(54) Apparatus and method

(76) Inventors: David Stephen Garrick, Gott (GB); Ronald Laurence Garrick, Ellon (GB)

Correspondence Address: Robert Cannuscio, Drinker Biddle & Reath, One Logan Square, 18th & Cherry Streets, Philadelphia, PA, 19103-6996, US

(21) Appl. No.: 10/476,898

(22) PCT Filed: May 2, 2002
(86) PCT No.: PCT/GB02/02026

(30) Foreign Application Priority Data
May 2, 2001 (GB) 0110731.7

(51) Int. Cl. B08B 9/20

(52) U.S. Cl. 134/25.1

(57) ABSTRACT

Apparatus and method for treating contaminated waste products, such as drill cuttings. The waste products are heated in a reactor vessel so that liquid contaminants evaporate, leaving solids that are safe for disposal.

This invention relates to apparatus and a method for treatment of waste products and by-products of industrial processes, and particularly to the treatment of drill cuttings recovered from oil and gas wells, and related activities.

Drill cuttings essentially comprise small chips of rock and other material from the formation being drilled, which are generated during the drilling process and are washed back to the surface of the well by drilling fluid (sometimes called drilling mud) circulated in the well. Conventional drilling muds are typically oil-based, and are often toxic, so disposal of drill cuttings contaminated with oil-based drilling mud is a significant problem as the environmental consequences of dumping oil-contaminated drill cuttings into the ocean are not acceptable. Therefore, many methods of treating drill cuttings to remove oil-based contamination have been devised in the field of offshore oil and gas well drilling. One common method of dealing with contaminated drill cuttings is to crack the hydrocarbons present in the contaminated drill cuttings in a rotary mill. Existing methods of this nature typically rely on raising the temperature of the hydrocarbons above around 300-350° C.

According to the present invention there is provided a method of treating contaminated waste products, the method comprising applying heat to the contaminated waste products in a reactor vessel so as to change the phase of the contaminant, and removing the contaminant from the reactor vessel after it has changed phase.

Typically the reactor vessel is a mill chamber.

Preferably the reactor vessel has a smooth interior surface.

The heat is typically generated in the reactor vessel by friction, and a preferred method of the invention employs a rotary mill to rotate flails attached to a rotor within the reactor vessel. The rotating flails beat the contaminated drill cuttings or other waste products at high-speed so as to generate heat within the reactor vessel. The amount of heat generated within the reactor vessel is typically fairly low, and the temperature typically rises within the reactor vessel to around 230-280° C., and typically 260-280° C.

The waste products in the vessel tend to collect in a bed of material at the radially outermost parts of the vessel and arrange themselves generally homogeneously against the smooth interior surface of the vessel. The flails therefore pass through the annular bed of waste products with a minimum of disruption/turbulence. The waste products generally remain in the bed on the inner surface of the vessel.

Since the method merely generates sufficient heat to change the phase of the contaminant, rather than cracking the contaminant and changing its molecular structure, it is more efficient and can run at lower temperatures than existing methods. Also valuable contaminants can be recovered without being cracked or changed at a molecular level.

Typically the method works best when treating solids contaminated by liquids, which evaporate in the heated reactor vessel and can easily be removed while in a gaseous phase, leaving a dry solid within the reactor chamber which can be removed after the process has been completed. In certain embodiments, the solid being treated (i.e. drill cuttings) can also be mechanically powdered by the rotary flails, leaving an inert powder which is safe for disposal in a conventional manner.

The present invention also provides apparatus for treating contaminated waste products, the apparatus comprising a reactor vessel, a device for applying heat to the contaminated waste products so as to change the phase of the contaminant, and an exhaust for removing the contaminant from the reactor vessel after it has changed phase.

The reactor optionally has temperature sensors that feedback information to the motor driving the rotor, so that the speed of the rotor within the reactor vessel (and therefore the temperature within the reactor vessel) can be controlled by the feedback information from the temperature sensor.

Alternatively the rotor can be run at a fixed speed. The material to be treated within the reactor chamber is typically fed into the reactor chamber on a pump or on a conveyor that can typically comprise a belt, an auger, a worm drive, or a similar device. In certain preferred embodiments of the invention, a screw conveyor is used to deliver material to be treated into the reactor chamber.

The apparatus typically includes some means for evacuation of the reactor chamber, so that the contaminants liberated into the gaseous phase from the contaminated mixture in the reactor chamber can be removed easily. Typically, the reactor is provided with a fan or pump to remove gas from the reactor chamber. Typically the gas removed from the reactor chamber is at a high temperature, and in some embodiments of the invention, the heat from the gas removed from the reactor chamber can be used to heat up the rotor, mill chamber or other parts of the reactor chamber or apparatus, so as to make the process more efficient.

Alternatively, the gas can be evacuated under simple convection without a fan. This can be an advantage as it avoids feeding oxygen into the reactor, which could pose a fire or explosion risk, and can have a cooling effect.

The gas removed from the reactor chamber is typically processed in one or more cyclones to remove dust particles from the gas, and is typically thereafter condensed or distilled or further processed to remove particular contaminants that may be particularly toxic, so that they can be disposed of carefully, or alternatively, to remove others that are particularly valuable, so that they can be recovered for commercial use. In certain preferred embodiments of the invention, hot or cold fluids recovered from or generated by the distillation process downstream of the reactor vessel can be stored and/or directed back to certain other parts of the apparatus which may require these during the process.

Certain embodiments of the invention use a grinding material in the reactor vessel to increase friction between the rotor flails and the material being treated, in order to increase the heat generated within the vessel. The flails can typically be operated while the vessel contains only the grinding material in order to increase the temperature within the vessel before the material to be treated is added.

An embodiment of the present invention will now be described by way of example and with reference to the accompanying drawings, in which:

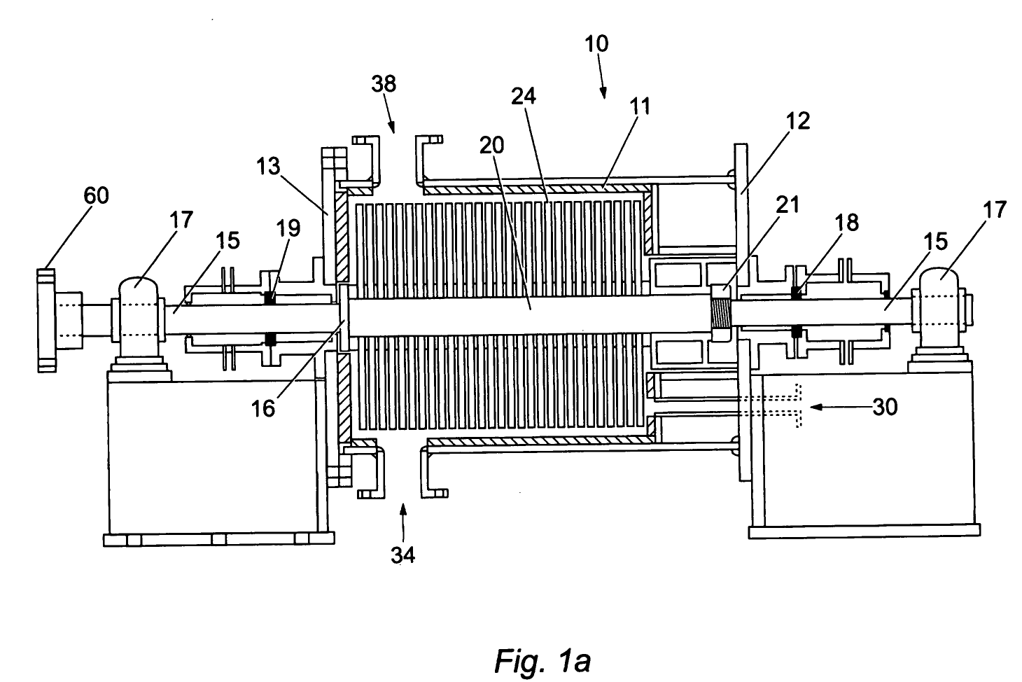

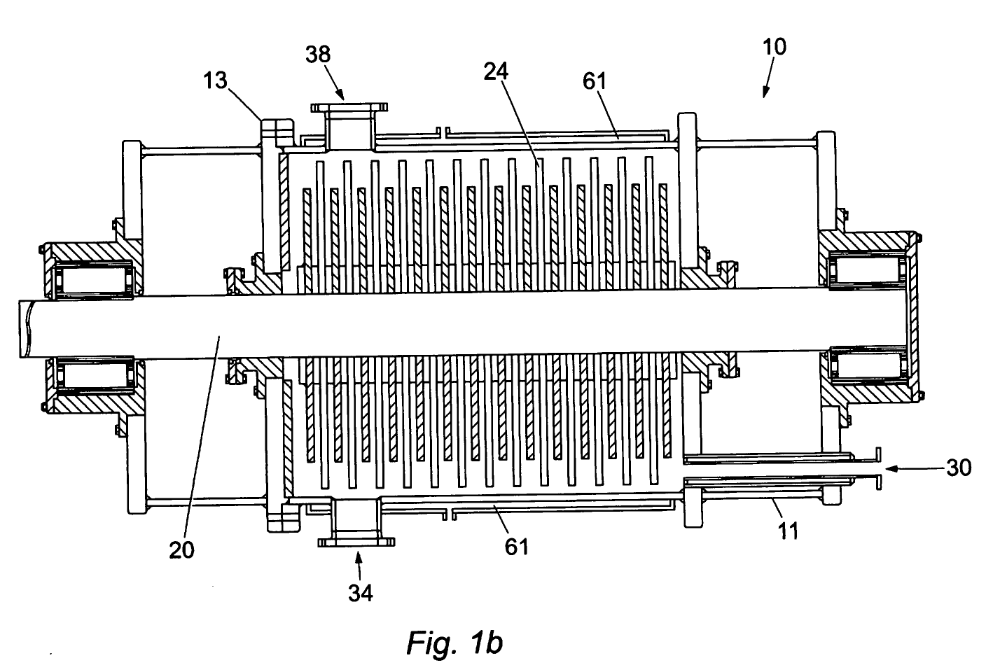

FIG. 1a shows a side view of a reactor vessel;

FIG. 1b shows a similar view of a further similar reactor vessel;

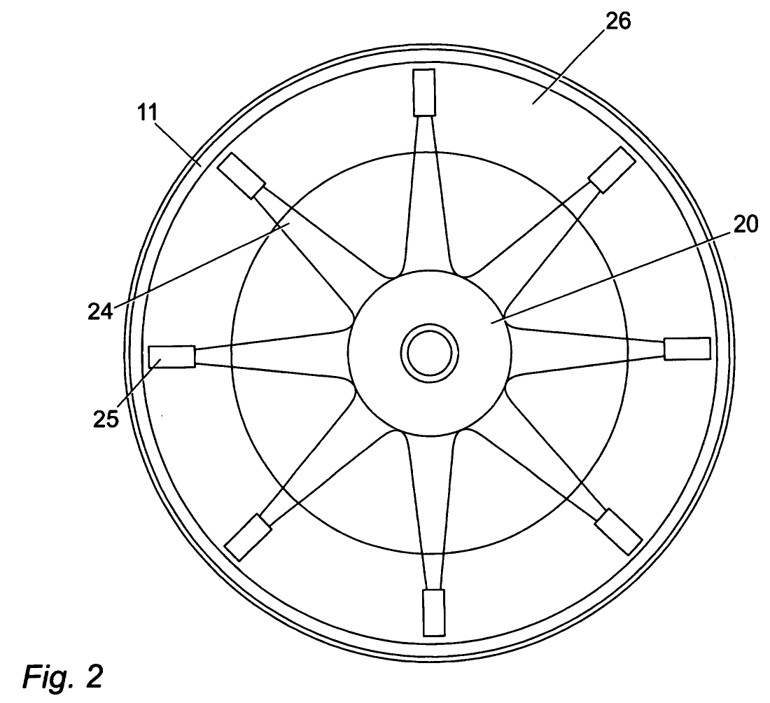

FIG. 2 shows an end sectional view of the FIG. 1 reactor vessel; and

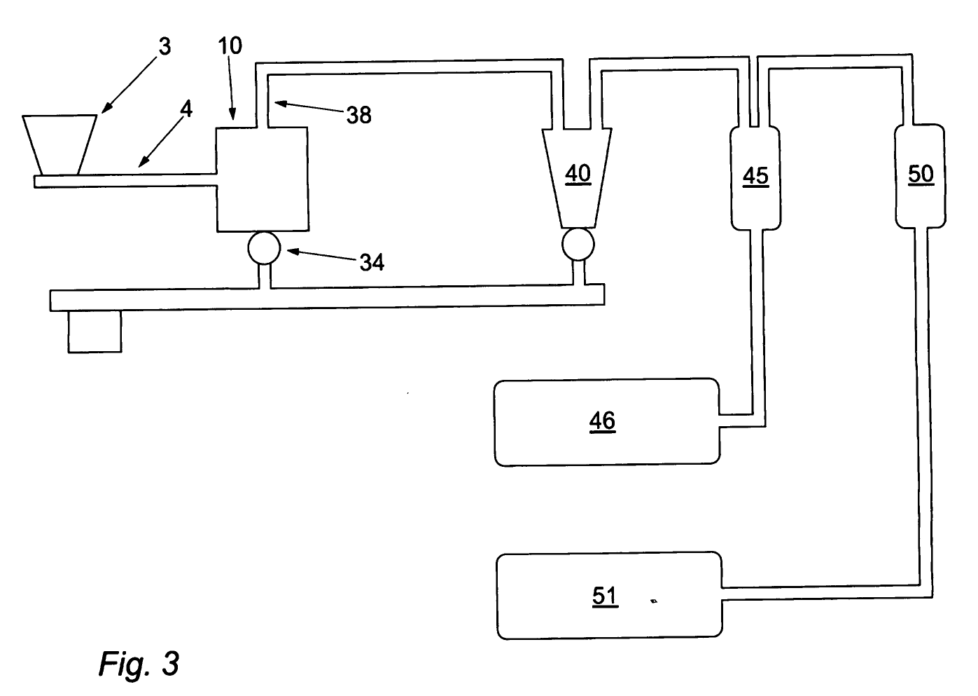

FIG. 3 shows a schematic side view of apparatus incorporating the FIG. 1 vessel.

Referring now to the drawings, apparatus for treating contaminated drill cuttings mixed with oil-based drilling mud comprises a reactor 10 to which cuttings to be treated to remove contaminating hydrocarbons are fed from a feed hopper 3 via a pump or screw conveyor 4.

The reactor 10 comprises a cylindrical tube 11 having end walls 12, 13, each of which have a central bore through which an axle 15 extends along the central axis of the tube 11. The axle 15 is mounted between mounting blocks 17 on opposing sides of the tube 11, and is sealed to the end walls 12 and 13 at seals 18 and 19. A rotor 20 disposed in the tube 11 has a central bore through which the axle 15 extends so that the rotor 20 is mounted on and is affixed to the axle 15 along the central axis of the tube 11. The rotor 20 is driven by a motor (not shown).

The rotor 20 has flails 24 extending radially from the central axis in 8 axially aligned rows spaced circumferentially around the axis of the axle 15. Two rows are shown in the side sectional view of FIG. 1. The rotor typically has 35-50 rows of flails, although the number depends on the axial length of the rotor, and can be varied within different embodiments of the invention. Each row is axially offset with respect to its neighbouring row by around 10-50 mm, and the preferred axial spacing is between around 30-40 mm. The ends of the flails can have heads 25 which extend radially to within around 5-20 mm of the smooth inner surface of the tube 11. The flails are typically 100-300 mm long and the typical radius of the tube 11 is 1-2 m. The spacing of the radial gap between the inner surface of the tube 11 and the radially outermost end of the head 25 is typically kept as small as possible to ensure that the heads 25 pass in an arc very closely to the inner surface of the tube 11. With fine drill cuttings or other material to be treated the gap can be smaller than with more coarse material. This enhances the breaking up of the drill cuttings within the reactor 10.

The rotor 20 can be rigidly attached to the axle 15 e.g. by welding, but in this embodiment the rotor 20 is slid onto the axle 15 and abuts against a flange 16 on the axle 15 and a bolt 21 is offered onto a threaded portion of the axle to be tightened against the rotor 20 and force it against the flange 21. Thus the rotor 20 can be removed from the axle 15 for servicing.

The tube 11 has an inlet 30 for contaminated drill cuttings from the hopper 3, an outlet for dry processed solids 34, and a flue 38. The flue 38 optionally has a fan to extract gasses from the chamber and leads to a cyclone where the gasses are spun to remove dust and other particulate matter, after which they are passed through an oil condenser 45 to recover hydrocarbons from the gasses to a tank 46, and thereafter are passed though a water condenser 50 to recover water to a tank 51. The lower temperature at which the reactor operates ensures that the hydrocarbons recovered are not cracked and can be recycled for commercial use.

The operating temperature is typically selected in accordance with the type of hydrocarbons that are being recovered from the contaminated drill cuttings or other material, and need not always be 260-270° C., but can be at or around the boiling point of the particular hydrocarbons being recovered. Therefore the present invention also provides a method of recovering hydrocarbons from drill cuttings, the method comprising heating the drill cuttings to around the boiling point of the hydrocarbons being recovered, so that the hydrocarbons are liberated from the drill cuttings in gas phase without changing their molecular structure, and removing the gas phase hydrocarbons from the drill cuttings in solid phase.

The reactor 10 is initially optionally loaded with a dry inert powder and the rotor 20 is then driven by a suitable motor (not shown but hydraulic motors are suitable) at a speed of 450-500 rpm (typical range of 300-700 rpm) for a period of 10-15 mins or until the temperature in the reactor 10 has risen to the optimum operating temperature of around 260-270° C., or to a temperature to suit the material being processed. The spinning flails create a centrifugal force which forces the powder on to the surface of the tube 11 to form a friction bed 26, i.e. a layer of material having a generally even depth over substantially the whole inner surface of the reactor. The smooth outer wall assists in this process by maintaining a uniform bed of material to give rise to efficient use of the energy used to generate the heat. The heat is produced by friction generated in the bed 26 between the flails 24 and the dry powder, but the initial heating step can be omitted to leave the drill cuttings to be heated themselves from ambient temperature, or the reactor 10 can be heated by applied heat from another source. The drill cuttings can also be pre-heated (e.g. by passing through a heat exchanger) prior to entering the reactor 10. A typical inert dry powder used in this step might be sand. Optionally, the reactor 10 can be heated by an oil jacket in order to aid the drying process.

Once the reactor 10 has reached the optimum operating temperature the screw conveyor or pump 4 is started to deliver the wet contaminated drill cuttings into the reactor through the inlet 30 while the rotor 20 is spinning. Prior to material entering the chamber the feed pipe containing the material to be processed can pass through a heat exchanger leading to materials obtaining preheating prior to entry thereby reducing the overall energy required within the process chamber. The centrifugal force generated by the spinning flails 24 also acts on the drill cuttings, which are forced into the friction bed 26 on the inner surface of the tube 11. The smooth surface of the tube 11 aids the uniform distribution of the drill cuttings and dry powder so that there is an even depth of material over the whole circumference of the tube 11.

The spinning flails 24 break up the clumps of drill cuttings and the friction produced between the flails 24, the drill cuttings and the friction bed 26 heats up the drill cuttings to the operating temperature of around 260-270° C. At this point, or as the materials (e.g. drill cuttings) enter the reactor, flash drying occurs and the contaminating hydrocarbons evaporate from the drill cuttings and are evacuated from the reactor through the flue 38 in their gas phase. The drill cuttings in the reactor 10 are macerated and move from the inlet end wall 12 towards the outlet 34 during which time any residual liquids are flashed off. The material leaving the outlet 34 is substantially dry powder, all of the contaminating hydrocarbons having been liberated from the solid phase cuttings and evacuated through the flue 38. The flails 26 continually generate heat, and this, optionally combined with external heating, maintains the reactor 10 at an adequate temperature to ensure the consistent drying of drill cuttings which are continuously entering and passing through the reactor 10.

Gas phase material evacuated through the flue 38 is passed through a cyclone 40 in order to remove particulate matter such as dust from the hydrocarbons, which are then passed sequentially through an oil condenser 45 and a water condenser 50, before recovered hydrocarbons and water are stored in tanks 46 and 51. Heat taken from the condensers can be used to heat fluid such as oil or water that can be fed into the rotor through fluid coupling 60 or to an oil jacket (not shown) in order to heat the reactor 10 and increase the efficiency of the process. Dust recovered from the cyclone 40 is deposited onto a conveyor for disposal by conventional means.

In a preferred embodiment, the outlet 34 comprises a valve that can open and close in response to feedback from sensors determining the amount of material in the reactor vessel. The reactor works best when filled to an optimum amount with contaminated drill cuttings, so that sufficient material in the reactor vessel is available for maceration by the flails and for the generation of heat by friction. With less material in the reactor vessel the frictional forces, and therefore the heat in the vessel, might fall, thereby reducing the efficiency of liberation of gas phase hydrocarbons. Therefore the reactor vessel is kept around 20-50% full by the outlet valve 34 closing when the reactor contains less than the optimum amount of material, and opening to deposit treated material onto a conveyor when the vessel contains more than the optimum amount. The sensor can be inside the reactor vessel or can preferably be situated in contact with the drive train of the rotor, and can measure the resistance to rotation of the rotor in the reactor chamber, being an indication of the amount of material in the chamber.

FIG. 1b shows a modified embodiment having identical parts to the FIG. 1a reactor, but having also an oil jacket 61 for heating the reactor with the heat recovered from the apparatus.

Modifications and improvements can be incorporated without departing from the scope of the invention.

1. A method of treating contaminated waste products, the method comprising applying heat to the contaminated waste products in a reactor vessel so as to change the phase of the contaminant, and removing the contaminant from the reactor vessel after it has changed phase.

2. A method according to claim 1, wherein the phase of the contaminant is changed without changing its molecular structure.

3. A method according to claim 1 or claim 2, wherein the heat is generated in the reactor vessel by friction.

4. A method according to any preceding claim, wherein rotating flails beat the contaminated waste products so as to generate heat within the reactor vessel.

5. A method according to claim 4, wherein the ends of the rotating flails pass close to the interior surface of the reactor vessel.

6. A method according to claim 4 or claim 5, wherein the flails are attached to a rotary shaft that is heated by an external source.

7. A method according to any preceding claim, wherein a grinding material is introduced into the reactor vessel.

8. A method according to claim 7 when dependent on any one of claims 4 to 6, wherein, prior to introducing the waste products, the flails are operated while the vessel contains only a grinding material.

9. A method according to any preceding claim, which further comprises the step of heating the reactor vessel from an external source.

10. A method according to claim 9, where the reactor vessel is heated by an oil jacket.

11. A method according to any preceding claim wherein the temperature within the reactor vessel rises to 230-280° C.

12. A method according to any preceding claim, wherein the temperature within the reactor vessel rises to 260-280° C.

13. A method according to any preceding claim, wherein the waste products are solids contaminated by liquids.

14. A method according to claim 13, wherein the liquids evaporate in the reactor vessel to form a gas, which is then removed from the reactor vessel.

15. A method according to claim 14, wherein heat from the gas removed from the vessel is used to heat parts of the apparatus.

16. A method according to claims 14 or claim 15, wherein the gas removed from the reactor vessel is processed in a cyclone to remove dust particles from the gas and the gas is then condensed or distilled or further processed to remove particular contaminants.

17. A method according to claim 16, wherein hot or cold fluids recovered from or generated by the distillation process are stored and/or directed back to other parts of the apparatus.

18. A method according to any one of claims 4 to 17, wherein the temperature of the reactor vessel is monitored and the speed to the flails is related to the temperature.

19. A method according to any preceding claim, wherein the amount of material in the reactor vessel is monitored, and the amount of waste products entering the vessel is related to the amount of material in the vessel.

20. Apparatus for treating contaminated waste products, the apparatus comprising a reactor vessel, a device for applying heat to the contaminated waste products so as to change the phase of the contaminant, and an exhaust for removing the contaminant from the reactor vessel after it has changed phase.

21. Apparatus according to claim 20, wherein the reactor vessel has a smooth interior surface.

22. Apparatus according to claim 20 or claim 21, having rotating flails to beat the contaminated waste products so as to generate heat within the reactor vessel.

23. Apparatus according to claim 22, wherein the reactor vessel has temperature sensors that feedback information to a motor which drives the flails.

24. Apparatus according to any one of claims 20 to 23, having a feeder means to feed the waste products into the reactor vessel.

25. Apparatus according to claim 24, wherein the feeder means is a screw conveyor.

26. Apparatus according to any one of claims 20 to 25, further comprising a means for evacuating contaminants in the gaseous phase from the reactor vessel.

27. Apparatus according to any one of claims 20 to 26, further comprising an external heating source.

28. A method of recovering hydrocarbons from drill cuttings, the method comprising heating the drill cuttings to around the boiling point of the hydrocarbons being recovered, so that the hydrocarbons are liberated from the drill cuttings in gas phase without changing their molecular structure, and removing the gas phase hydrocarbons from the drill cuttings in solid phase.
